(19) United States
(12) Patent Application Publication
(10) Pub. No.: US 2010/0122064 A1
(43) Pub. Date: May 13, 2010

(54) METHOD FOR INCREASING CONFIGURATION RUNTIME OF TIME-SLICED CONFIGURATIONS

(76) Inventor: MARTIN VORBACH, Lingenfeld (DE)

Correspondence Address: KENYON & KENYON LLP, ONE BROADWAY, NEW YORK, NY, 10004, US

(21) Appl. No.: 12/571,195

(22) Filed: Sep. 30, 2009

Related U.S. Application Data
(63) Continuation of application No. 10/551,891, filed on Aug. 28, 2006.

(30) Foreign Application Priority Data
Apr. 4, 2003 (DE) 103 15 295.4
May 15, 2003 (DE) 103 21 834.3

(51) Int. Cl. G06F 15/76; G06F 12/08; G06F 1/32; G06F 9/02; G06F 9/302; G06F 9/305; G06F 9/312

(52) U.S. Cl. 712/34; 711/130; 713/324; 712/32; 712/221; 712/223; 712/207; 711/E12.017; 712/E09.002; 712/E09.017; 712/E09.018; 712/E09.033

(57) ABSTRACT

A device may include a data processing logic cell field and one or more sequential CPUs. The logic cell field and the CPUs may be configured to be coupled to each other for data exchange. The data exchange may be in block form using lines leading to a cache memory. In a method for operating a reconfigurable unit having runtime-limited configurations, the configurations may be able to increase their maximum allowed runtime, e.g., by triggering a parallel counter. An increase in configuration runtime by the configurations may be suppressed in response to an interrupt.

### FIELD OF THE INVENTION

The present invention relates to improvements in the use of reconfigurable processor technologies for data processing.

### BACKGROUND INFORMATION

With respect to a design of logic cell fields, reference is made here to the XPP architecture and previously published patent applications as well as more recent patent applications by the present applicant, these documents being fully incorporated herewith for disclosure purposes. The following documents should thus be mentioned in particular: DE 44 16 881 A1, DE 197 81 412 A1, DE 197 81 483 A1, DE 196 54 846 A1, DE 196 54 593 A1, DE 197 04 044.6 A1, DE 198 80 129 A1, DE 198 61 088 A1, DE 199 80 312 A1, PCT/DE 00/01869, DE 100 36 627 A1, DE 100 28 397 A1, DE 101 10 530 A1, DE 101 11 014 A1, PCT/EP 00/10516, EP 01 102 674 A1, DE 198 80 128 A1, DE 101 39 170 A1, DE 198 09 640 A1, DE 199 26 538.0 A1, DE 100 50 442 A1, PCT/EP 02/02398, DE 102 40 000, DE 102 02 044, DE 102 02 175, DE 101 29 237, DE 101 42 904, DE 101 35 210, EP 01 129 923, PCT/EP 02/10084, DE 102 12 622, DE 102 36 271, DE 102 12 621, EP 02 009 868, DE 102 36 272, DE 102 41 812, DE 102 36 269, DE 102 43 322, EP 02 022 692, EP 02 001 331, and EP 02 027 277.

One problem in traditional approaches to reconfigurable technologies is encountered when the data processing is performed primarily on a sequential CPU using a configurable data processing logic cell field or the like and/or when data processing involving a plurality of processing steps and/or extensive processing steps to be performed sequentially is desired.

There are known approaches which are concerned with how data processing may be performed on both a CPU and a configurable data processing logic cell field.

WO 00/49496 describes a method for executing a computer program using a processor which includes a configurable functional unit capable of executing reconfigurable instructions, whose effect is redefinable in runtime by loading a configuration program, this method including the steps of selecting combinations of reconfigurable instructions, generating a particular configuration program for each combination, and executing the computer program. Each time an instruction from one of the combinations is needed during execution and the configurable functional unit is not configured using the configuration program for this combination, the configuration program for all the instructions of the combination is to be loaded into the configurable functional unit. In addition, a data processing device having a configurable functional unit is known from WO 02/50665 A1, where the configurable functional unit is used to execute instructions according to a configurable function. The configurable functional unit has a plurality of independent configurable logic blocks for executing programmable logic operations to implement the configurable function. Configurable connecting circuits are provided between the configurable logic blocks and both the inputs and outputs of the configurable functional unit. This allows optimization of the distribution of logic functions over the configurable logic blocks.

One problem with traditional architectures occurs when coupling is to be performed and/or technologies such as data streaming, hyperthreading, multithreading and so forth are to be utilized in a logical and performance-enhancing manner. A description of an architecture is given in “Exploiting Choice: Instruction Fetch and Issue on Implementable Simultaneous Multi-Threading Processor,” Dean N. Tulson, Susan J. Eggers et al., Proceedings of the 23^{rd} Annual International Symposium on Computer Architecture, Philadelphia, May 1996.

Hyperthreading and multithreading technologies have been developed in view of the fact that modern microprocessors gain their efficiency from many specialized functional units and functional units triggered like a deep pipeline as well as high memory hierarchies; this allows high frequencies in the function cores. However, due to the strictly hierarchical memory arrangements, there are major disadvantages in the event of faulty access to caches because of the difference between core frequencies and memory frequencies, since many core cycles may elapse before data is read out of the memory. Furthermore, problems occur with branchings and in particular incorrectly predicted branchings. It has therefore been proposed that a switch be performed between different tasks as a simultaneous multithreading (SMT) procedure whenever an instruction is not executable or does not use all functional units.

The technology of the above-cited exemplary documents (not by the present applicant) involves, among other things, an arrangement in which configurations are loadable into a configurable data processing logic cell field, but in which data exchange between the ALU of the CPU and the configurable data processing logic cell field, whether an FPGA, DSP or the like, takes place via registers. In other words, data from a data stream must first be written sequentially into registers and then stored in these registers sequentially again. Another problem occurs when there is to be external access to data, because even then there are still problems in the chronological data processing sequence in comparison with the ALU and in the allocation of configurations, and so forth. Traditional arrangements, such as those known from protective rights not held by the present applicant, are used, among other things, for processing functions in the configurable data processing logic cell field, DFP, FPGA or the like, which are not efficiently processable on the ALU of the CPU. The configurable data processing logic cell field is thus used in practical terms to permit user-defined opcodes which allow more efficient processing of algorithms than would be possible on the ALU arithmetic unit of the CPU without configurable data processing logic cell field support.

In the related art, as has been recognized, coupling is thus usually word-based but not block-based, as would be necessary for data streaming processing. It is initially desirable to permit more efficient data processing than would be the case with close coupling via registers.

Another possibility for using logic cell fields of logic cells having a coarse and/or fine granular structure and logic cells and logic cell elements having a coarse and/or fine granular structure involves a very loose coupling of such a field to a traditional CPU and/or a CPU core with embedded systems. A traditional sequential program, e.g., a program written in C, C++ or the like, may run on a CPU or the like, data stream processing calls being instantiated by this program on the finely and/or coarsely granular data processing logic cell field. It is then problematic that in programming for this logic cell field, a program not written in C or another sequential high-level language must be provided for data stream processing. It would be desirable here for C programs or the like to be processable on both the traditional CPU architecture and on a data processing logic cell field operated jointly together with it, i.e., a data streaming capability is nevertheless maintained in quasi-sequential program processing using the data processing logic cell field in particular, whereas CPU operation, in particular using a coupling which is not too loose, remains possible at the same time.

It is also already known that within a data processing logic cell field system such as that known in particular from PACT02 (DE 196 51 075.9-53, WO 98/26356), PACT04 (DE 196 54 846.2-53, WO 98/29952), PACT08 (DE 197 04 728.9, WO 98/35299), PACT13 (DE 199 26 538.0, WO 00/77652), PACT31 (DE 102 12 621.6-53, PCT/EP 02/10572), sequential data processing may also be provided within the data processing logic cell field. However, for example to save resources, to achieve time optimization and so forth, partial processing is achieved within a single configuration without this resulting in a programmer being able to automatically and easily implement a piece of high-level language code on a data processing logic cell field, as is the case with traditional machine models for sequential processors. Implementation of high-level language code on data processing logic cell fields according to the models for sequentially operating machines still remains difficult.

It is also known from the related art that multiple configurations, each triggering a different mode of functioning of array parts, may be processed simultaneously on the processor array (PA) and that a switch in one or more configurations may take place without any disturbance in others during runtime. Methods and arrangements for their implementation in hardware are known; processing of partial configurations to be loaded into the field may be performed without a deadlock. Reference is made here in particular to the patent applications pertaining to the FILMO technology, e.g., PACT05 (DE 196 54 593.5-53, WO 98/31102), PACT10 (DE 198 07 872.2, WO 99/44147, WO 99/44120), PACT13 (DE 199 26 538.0, WO 00/77652), PACT17 (DE 100 28 397.7), WO 02/13000); PACT31 (DE 102 12 621.6, WO 03/036507). This technology already permits parallelization to a certain extent and, with appropriate design and allocation of the configurations, also permits a type of multitasking/multithreading of such a type that planning, i.e., scheduling and/or time use planning control, is provided. Time use planning control arrangements and methods are thus known per se from the related art, allowing multitasking and/or multithreading at least with appropriate allocation of configurations to individual tasks and/or threads to configurations and/or configuration sequences.

### SUMMARY OF THE INVENTION

Embodiments of the present invention provide a novel device and method for commercial application.

In an example embodiment of the present invention, a device may be provided that includes a data processing logic cell field and one or more sequential CPUs. The logic cell field and the CPUs may be configured to be coupled to each other for data exchange. The data exchange may be, e.g., in block form using lines leading to a cache memory.

In an example embodiment of the present invention, a method for operating a reconfigurable unit having runtime-limited configurations may be provided. The configurations may be able to increase their maximum allowed runtime, e.g., by triggering a parallel counter. An increase in configuration runtime by the configurations may be suppressed in response to an interrupt.

### BRIEF DESCRIPTION OF THE DRAWINGS

FIG. 1 includes diagrams illustrating passing of data between a data processing logic cell field and memory, according to exemplary embodiments of the present invention.

FIG. 2 is a diagram that illustrates a structure that provides for shutting down a cache in slices via power disconnections, according to an example embodiment of the present invention.

FIG. 3 includes diagrams that illustrate different arrangements of FPGAs and ALUs and/or EALUs of a logic cell field, according to exemplary embodiments of the present invention.

FIGS. 4a to 4c are diagrams that illustrate architectures in which an SMT processor is coupled to an XPP thread resource, according to exemplary embodiments of the present invention.

FIG. 5 is a diagram that illustrates an embodiment of the present invention in which a pseudo-random noise may be generated using a single cell if individual output bits obtained stepwise always from a single FPGA cell are written back to the FPGA cell.

FIGS. 6a to 6c are diagrams and a table that illustrate a task switch, a thread switch, and/or a hyperthread switch, according to exemplary embodiments of the present invention.

### DETAILED DESCRIPTION OF THE INVENTION

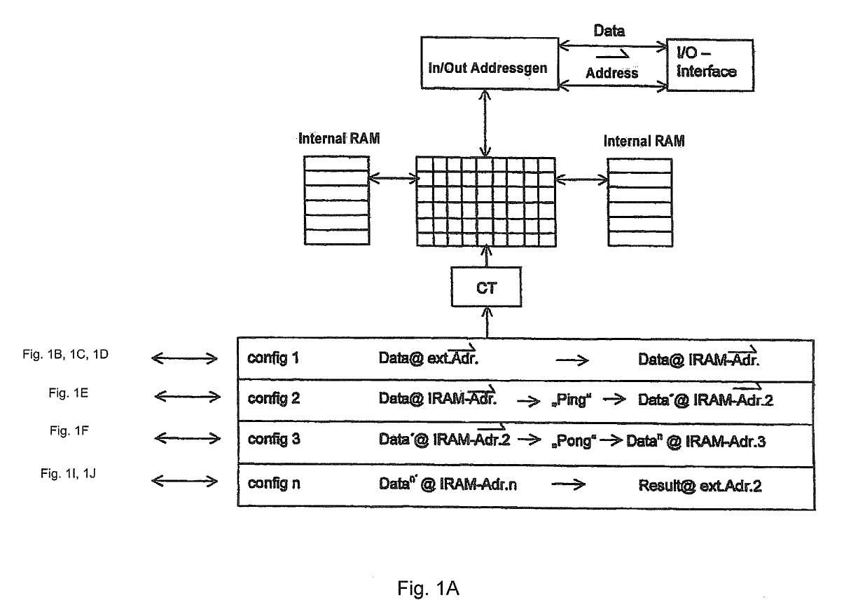

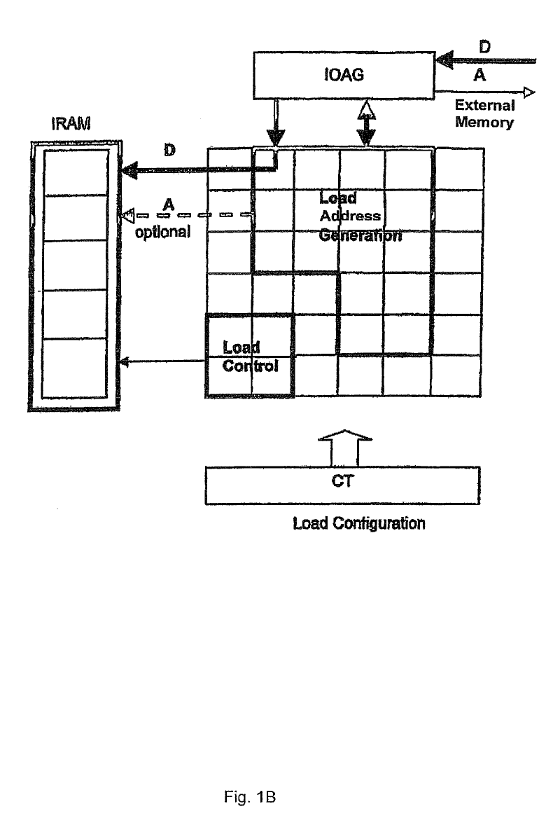

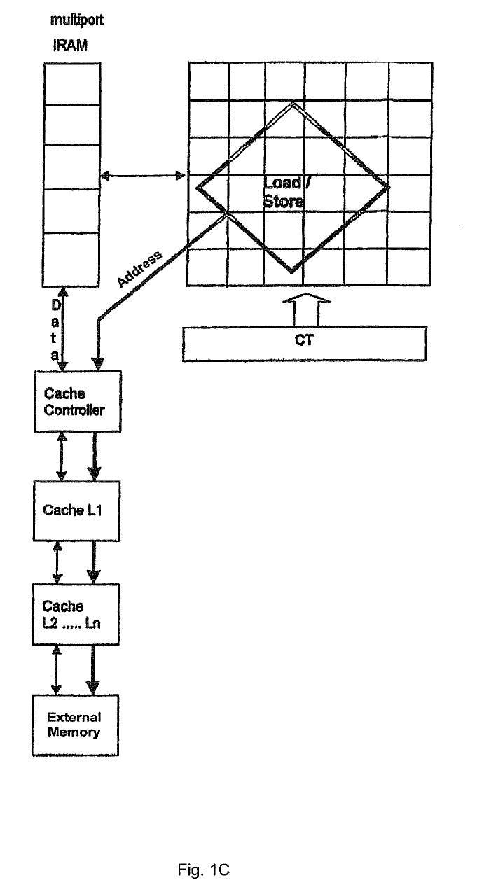

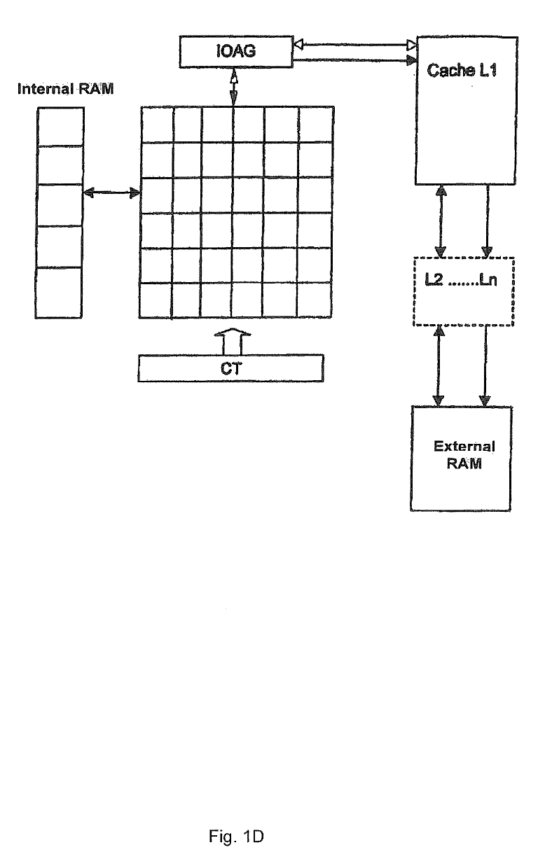

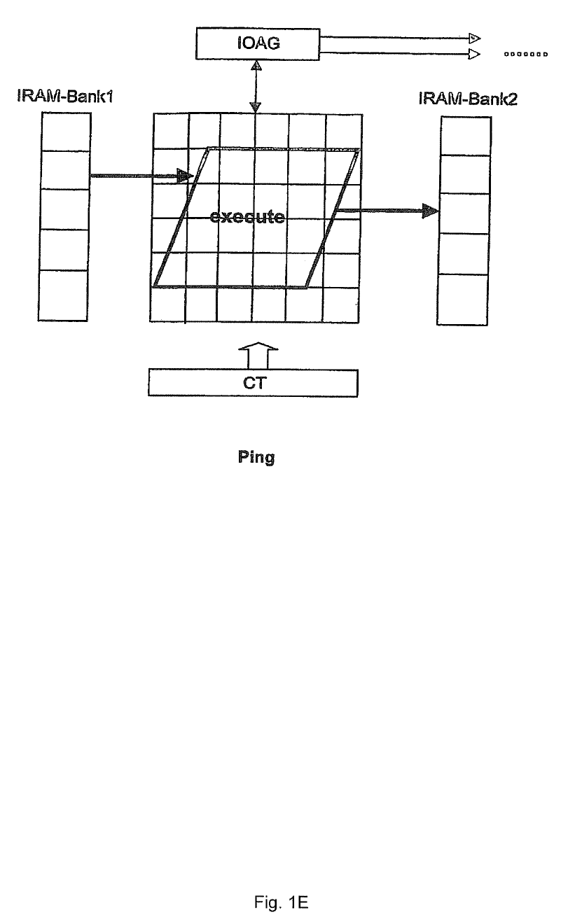

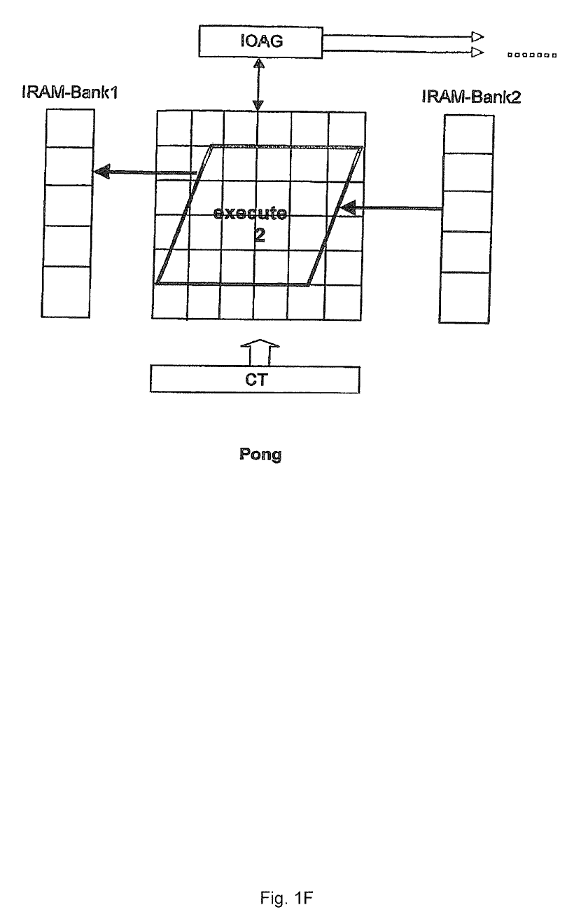

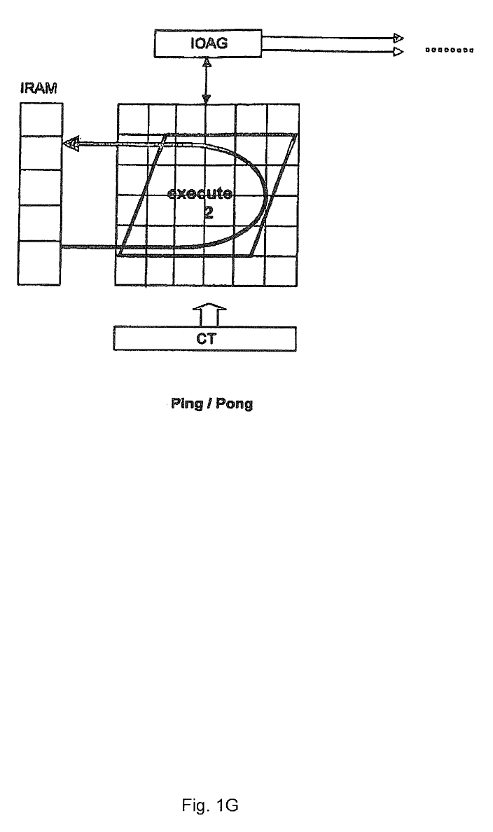

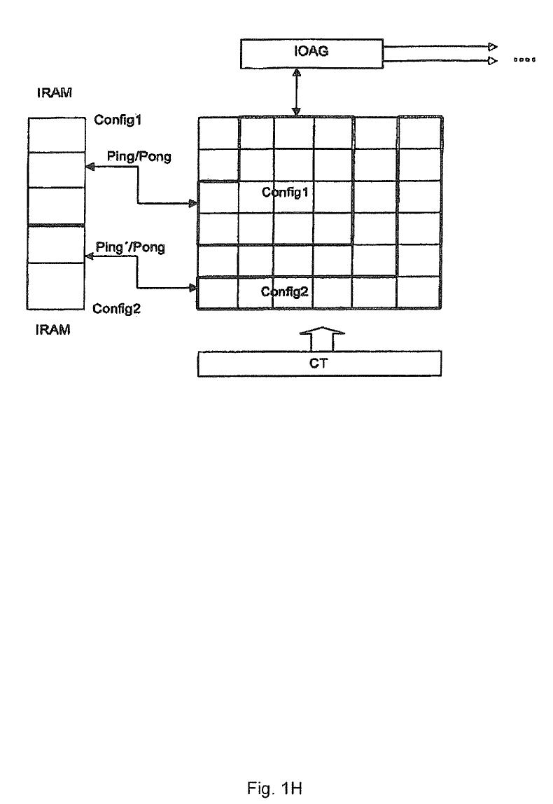

In an example embodiment of the present invention, data may be supplied to the data processing logic cell field in response to execution of a load configuration by the data processing logic cell field, and/or data from this data processing logic cell field may be written back (STORED) by processing a STORE configuration accordingly. These load configurations and/or memory configurations may be designed in such a way that addresses of memory locations to be accessed directly or indirectly by loading and/or storage are generated directly or indirectly within the data processing logic cell field. Through this configuration of address generators within a configuration, a plurality of data may be loadable into the data processing logic cell field, where it may be stored in internal memories (iRAM), if necessary, and/or in internal cells such as EALUs having registers and/or internal memory arrangements. The load configuration and/or memory configuration may thus allow loading of data by blocks, almost like data streaming, in particular being comparatively rapid in comparison with individual access, and such a load configuration may be executable before one or more configurations that process data by actually analyzing and/or modifying it, with which configuration(s) the previously loaded data is processed. Data loading and/or writing may typically take place in small areas of large logic cell fields, while other subareas may be involved in other tasks. Reference is made to FIG. 1 for these and other particulars of the present invention. In the ping-pong-like data processing described in other published documents by the present applicant in which memory cells are provided on both sides of the data processing field, one memory side may be preloaded with new data by a LOAD configuration in an array part, while data from the opposite memory side having a STORE configuration may be written back in another array part; in a first processing step. Data from the memory on one side may stream through the data processing field to the memory on the other side. Intermediate results obtained in the first stream through the field may be stored in the second memory, the field may be reconfigured, if necessary, and the interim results may then stream back for further processing, etc. This simultaneous LOAD/STORE procedure is also possible without any spatial separation of memory areas.

It should be pointed out again that there are various possibilities for filling internal memories with data. The internal memories may be preloaded in advance in particular by separate load configurations using data streaming-like access. This would correspond to use as vector registers, and may result in the internal memories always being at least partially a part of the externally visible state of the XPP and therefore having to be saved, i.e., written back when there is a context switch. Alternatively and/or additionally, the internal memories (iRAMs) may be loaded onto the CPU through separate “load instructions.” This may result in reduced load processes through configurations and may result in a broader interface to the memory hierarchy. Here again, access is like access to vector registers.

Preloading may also include a burst from the memory through instruction of the cache controller. Moreover it is possible (and may be preferred as particularly efficient in many cases) to design the cache in such a way that a certain preload instruction maps a certain memory area, which may be defined by the starting address and size and/or increment(s), onto the internal memory (iRAM). If all internal RAMs have been allocated, the next configuration may be activated. Activation may entail waiting until all burst-like load operations are concluded. However, this may be transparent if preload instructions are output long enough in advance and cache localization is not destroyed by interrupts or a task switch. A “preload clean” instruction may then be used in particular, preventing data from being loaded out of memory.

A synchronization instruction may be required to ensure that the content of a specific memory area stored cache-like in iRAM may be written back to the memory hierarchy, which may be accomplished globally or by specifying the accessed memory area. Global access corresponds to a “full write-back.” To simplify preloading of the iRAM, it is possible to specify this by giving a basic address, optionally one or more increments (in the event of access to multidimensional data fields), and a total run length, to store these in registers or the like, and then to access these registers for determining how loading is to be performed.

In one example embodiment of the present invention, registers may be designed as FIFOs. One FIFO may then also be provided for each of a plurality of virtual processors in a multithreading environment. Moreover, memory locations may be provided for use as TAG memories, as is customary with caches.

Marking the content of iRAMS as “dirty” in the cache sense may be helpful, so that the contents may be written back to an external memory as quickly as possible if the contents are not to be used again in the same iRAM. Thus, the XPP field and the cache controller may be considered as a single unit because they do not need different instruction streams. Instead, the cache controller may be regarded as the implementation of the steps “configuration fetch,” “operand fetch” (iRAM preload) and “write-back,” i.e., CF, OF and WB, in the XPP pipeline, the execution stage (ex) also being triggered. In one embodiment, due to the long latencies and unpredictability, e.g., due to faulty access to the cache or configurations of different lengths, steps may be overlapped for the width of multiple configurations, the configuration and data preloading FIFO (pipeline) being used for the purpose of loose coupling. The FILMO, which is known per se, may be situated downstream from the preload. Further, preloading may be speculative, the measure of speculation being determined as a function of the compiler. However, there is no disadvantage in incorrect preloading inasmuch as configurations which have only been preloaded but have not been executed are readily releasable for overwriting, just as is the assigned data. Preloading of FIFO may take place several configurations in advance and may depend, for example, on the properties of the algorithm. It is also possible to use hardware for this purpose.

With regard to writing back data used from iRAM to external memories, this may be accomplished by a suitable cache controller allocated to the XPP, but, in this case, it may typically prioritize its tasks and may preferentially execute preload operations having a high priority because of the assigned execution status. However, preloading may also be blocked by a higher-level iRAM instance in another block or by a lack of empty iRAM instances in the target iRAM block. In the latter case, the configuration may wait until a configuration and/or a write-back is concluded. The iRAM instance in a different block may then be in use or may be “dirty.” It is possible to provide for the clean iRAMs used last to be discarded, i.e., to be regarded as “empty.” If there are neither empty nor clean iRAM instances, then it may be required for a “dirty” iRAM part and/or a nonempty iRAM part to be written back to the memory hierarchy. Only one instance may be in use at one time, and there should be more than one instance in an iRAM block to achieve a cache effect, so it is impossible that there are neither empty nor clean nor dirty iRAM instances.

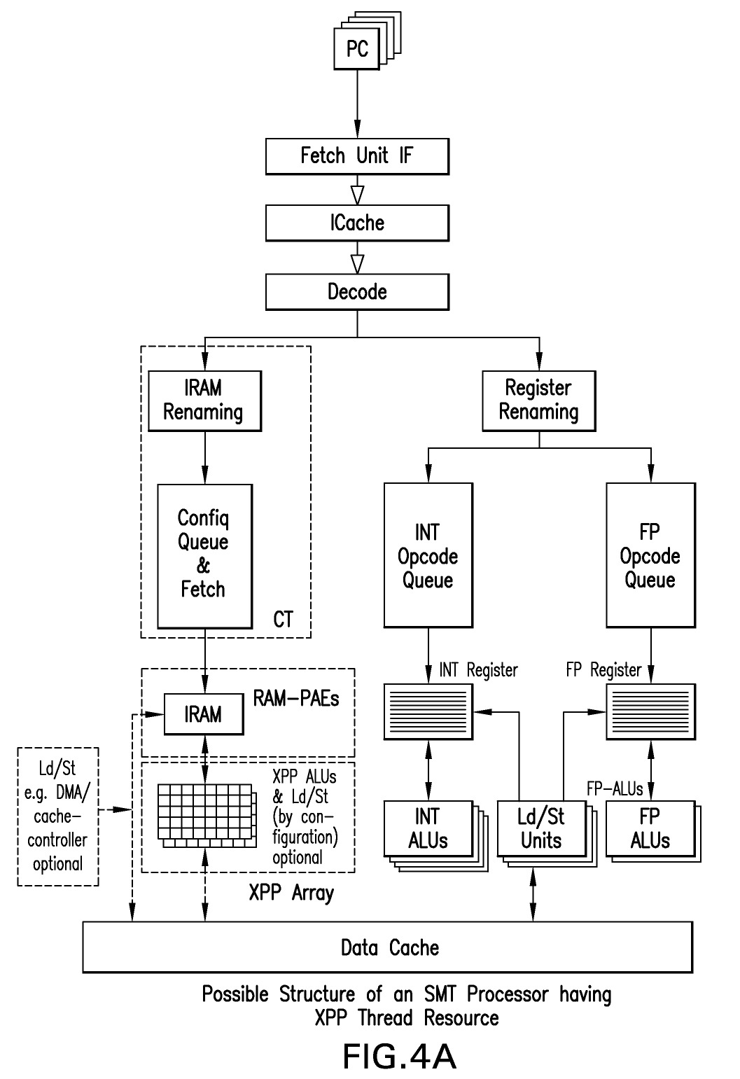

FIGS. 4a through 4c illustrate examples of architectures in which an SMT processor is coupled to an XPP thread resource.

It may be necessary to limit the memory traffic, which may be possible in various ways during a context switch. For example, strict read data need not be stored, as is the case with configurations, for example. In the case of uninterruptible (non-preemptive) configurations, the local states of buses and PAEs need not be stored.

It is possible to provide for only modified data to be stored, and cache strategies may be used to reduce memory traffic. To do so, a Least Recently Used (LRU) strategy may be implemented in particular in addition to a preload mechanism, in particular when there are frequent context switches.

In an example embodiment of the present invention, if iRAMs are defined as local cache copies of the main memory and a starting address and modification state information are assigned to each iRAM, the iRAM cells may be replicated, as is also the case for SMT support, so that only the starting addresses of the iRAMs need be stored and loaded again as context. The starting addresses for the iRAMs of an instantaneous configuration may then select the iRAM instances having identical addresses for use. If no address TAG of an iRAM instance corresponds to the address of the newly loaded context or the context to be newly loaded, the corresponding memory area may be loaded into an empty iRAM instance, this being understood here as a free iRAM area. If no such area is available, it is possible to use the methods described above.

Moreover, delays caused by write-backs may be avoidable by using a separate state machine (cache controller), with which an attempt may be made in particular to write back iRAM instances which are inactive at the moment during unneeded memory cycles.

As is apparent from the preceding discussion, the cache may be preferably interpreted as an explicit cache and not as a cache which is transparent to the programmer and/or compiler as is usually the case. To provide the proper triggering here, configuration preload instructions, which precede iRAM preload instructions used by that configuration, may be output, e.g., by the compiler. Such configuration preload instructions should be provided by the scheduler as soon as possible. Furthermore, i.e., alternatively and/or additionally, iRAM preload instructions which should likewise be provided by the scheduler at an early point in time may also be provided, and configuration execution instructions that follow iRAM preload instructions for this configuration may also be provided, these configuration execution instructions optionally being delayed, in particular by estimated latency times, in comparison with the preload instructions.

It is also possible to provide for a configuration wait instruction to be executed, followed by an instruction which orders a cache write-back, both being output by the compiler, in particular when an instruction of another functional unit such as the load/memory unit is able to access a memory area which is potentially dirty or in use in an iRAM. Synchronization of the instruction flows and cache contents may thus be forced while avoiding data hazards. Through appropriate handling, such synchronization instructions are not necessarily common.

Data loading and/or storing need not necessarily take place in a procedure which is entirely based on logic cell fields. Instead, it is also possible to provide one or more separate and/or dedicated DMA units, i.e., DMA controllers in particular, which are configured, i.e., functionally prepared, i.e., set up, e.g., by specifications with regard to starting address, increment, block size, target addresses, etc., in particular by the CT and/or from the logic cell field.

Loading may also be performed from and into a cache in particular. This may have the advantage that external communication with larger memory banks is handled via the cache controller without having to provide separate switching arrangements within the data processing logic cell field; read or write access in the case of cache memory arrangements is typically very fast and has a low latency time; and typically a CPU unit is also connected to this cache, typically via a separate LOAD/STORE unit, so that access to data and exchange thereof by blocks may take place quickly between the CPU core and data processing logic cell field, so that a separate command need not be fetched from the opcode fetcher of the CPU and processed for each transfer of data.

This cache coupling has also proven to be much more favorable than coupling of a data processing logic cell field to the ALU via registers if these registers communicate with a cache only via a LOAD/STORE unit, as is known per se from the non-PACT publications cited above.

Another data link to the load/memory unit of a sequential CPU unit assigned to the data processing logic cell field and/or to its registers may be provided.

Such units may respond via separate input/output terminals (IO ports) of the data processing logic cell array designable in particular as a VPU and/or XPP and/or through one or more multiplexers downstream from a single port.

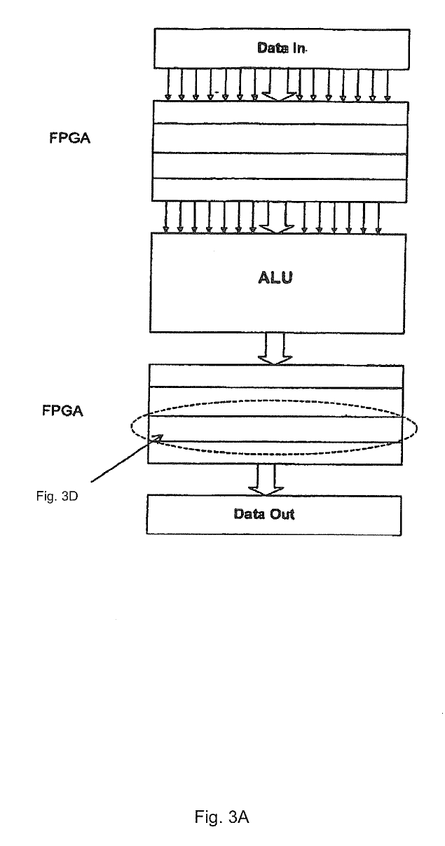

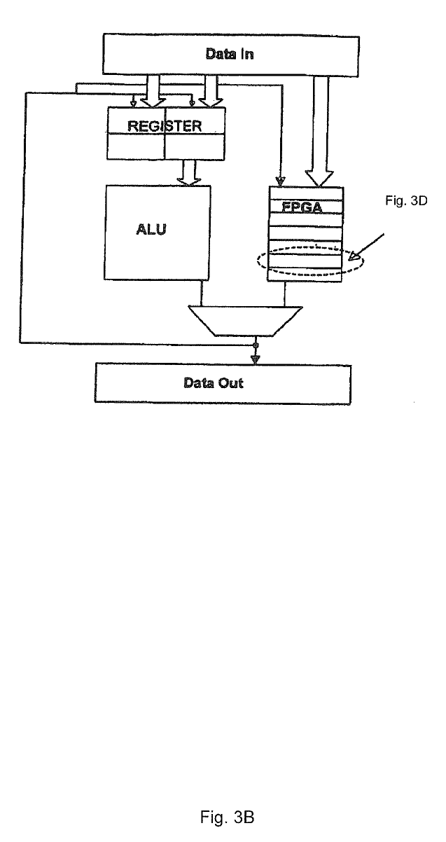

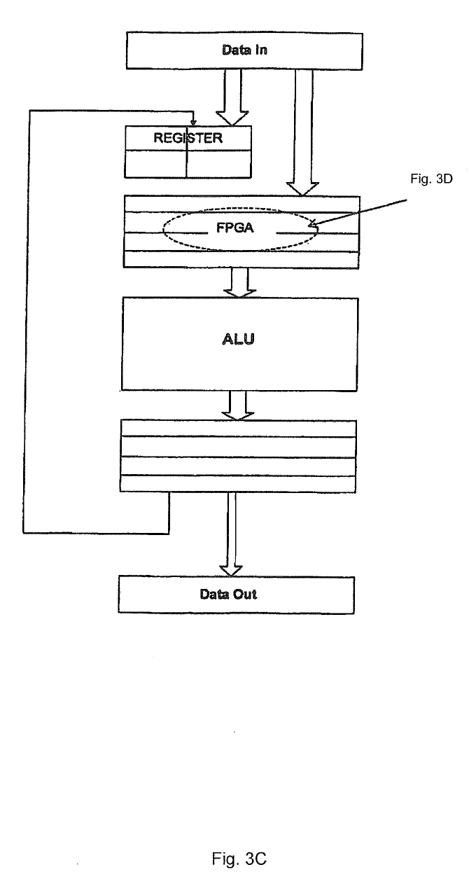

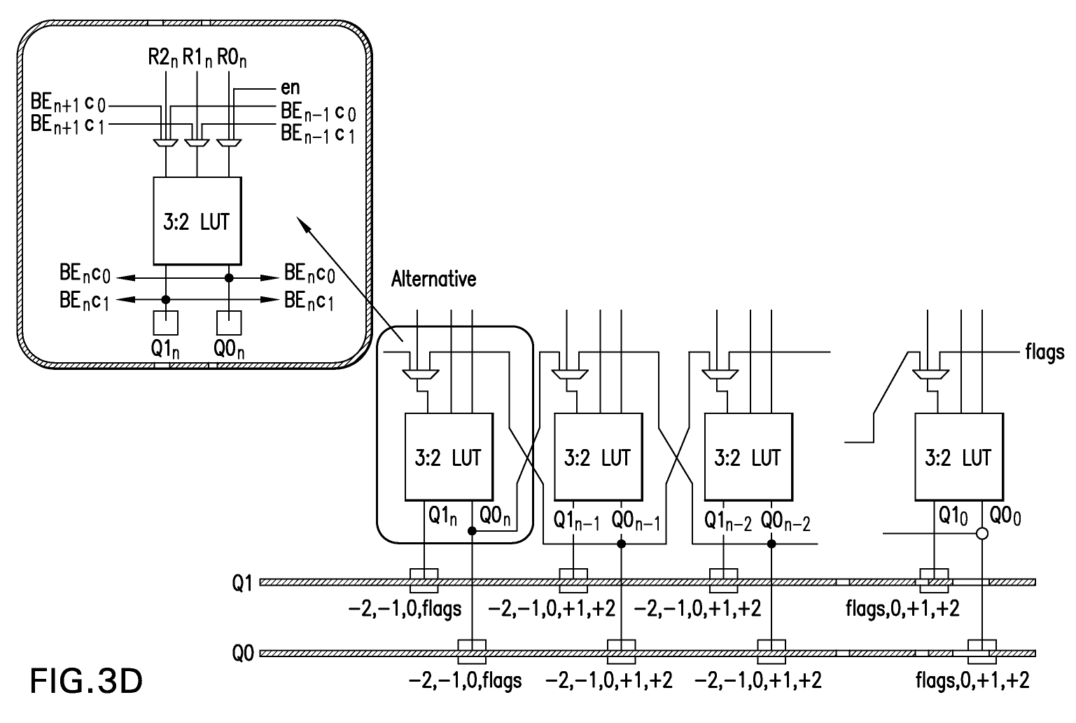

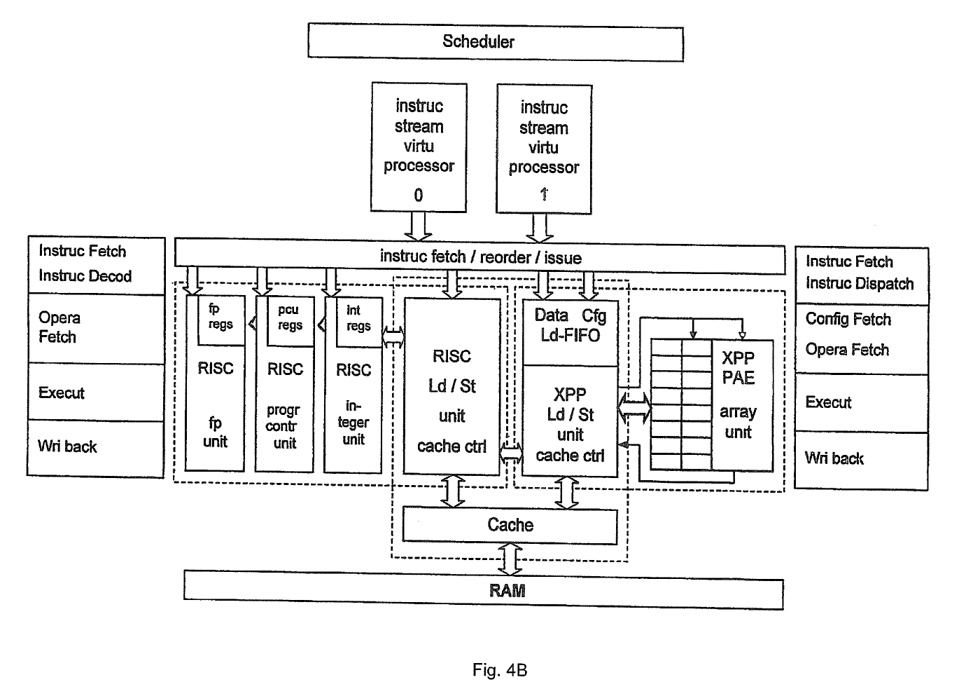

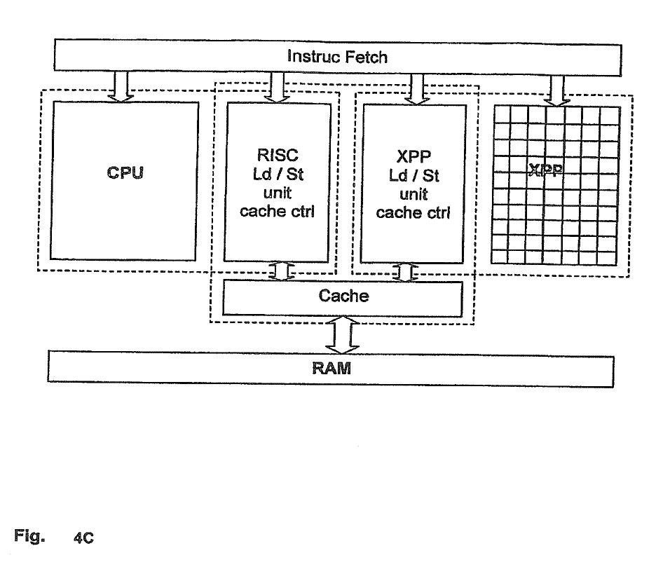

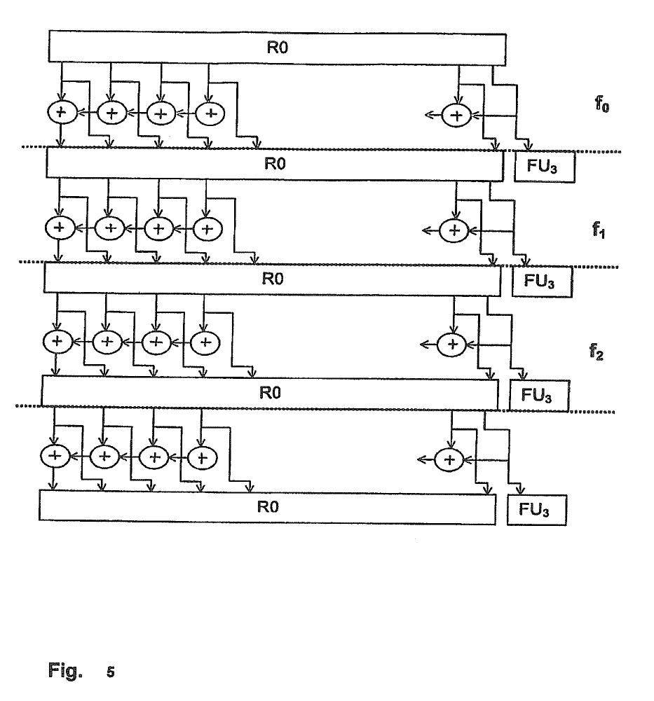

In addition to blockwise and/or streaming and/or random reading and/or writing access, in particular in read-modify-write mode (RMW) mode to cache areas and/or the LOAD/STORE unit and/or the connection (known per se in the related art) to the register of the sequential CPU, there may also be a connection to an external bulk memory such as a RAM, a hard drive and/or another data exchange port such as an antenna, etc. A separate port may be provided for this access to cache arrangements and/or LOAD/STORE units and/or memory arrangements different from register units. Suitable drivers, buffers, signal processors for level adjusting and so forth may be provided, e.g., LS74244, LS74245. The logic cells of the field may include ALUs and/or EALUs, in particular but not exclusively for processing a data stream flowing in or into the data processing logic cell field, and typically short fine-granularly configurable FPGA type circuits may be provided upstream from them at the inlet and/or outlet ends, in particular at both the inlet and outlet ends, and/or may be integrated into the PAE-ALU to cut bit blocks out of a continuous data stream, for example, as is necessary for MPEG4 decoding. This may be advantageous when a data stream is to enter the cell and is to be subjected there to a type of preprocessing without blocking larger PAEs units of this type. This may also be of particular advantage when the ALU is designed as a SIMD arithmetic unit, in which case a very long data input word having a data length of 32 bits, for example, may then be split up via the upstream FPGA-type strips into a plurality of parallel data words having a length of 4 bits, for example, which may then be processed in parallel in the SIMD arithmetic units, which is capable of significantly increasing the overall performance of the system, if corresponding applications are needed. FPGA-type upstream and/or downstream structures were discussed above. However, FPGA-type does not necessarily refer to 1-bit granular arrangements. It is possible in particular to provide, instead of these hyperfine granular structures, only fine granular structures having a width of 4 bits, for example. In other words, FPGA-type input and/or output structures upstream and/or downstream from an ALU unit designed as a SIMD arithmetic unit in particular may be configurable, for example, so that 4-bit data words are always supplied and/or processed. It may be possible to provide cascading here so that, for example, the incoming 32-bit-long data words stream into four separate and/or separating 8-bit FPGA-type structures positioned side by side, a second strip having eight 4-bit-wide FPGA-type structures is downstream from these four 8-bit-wide FPGA-type structures and then, if necessary, after another such strip, if necessary for the particular purpose, sixteen parallel 2-bit wide FPGA-type structures are also provided side by side, for example. If this is the case, a substantial reduction in configuration complexity may be achieved in comparison with strictly hyperfine granular FPGA-type structures. This may also result in the configuration memory of the FPGA-type structure possibly turning out to be much smaller, thus permitting a savings in terms of chip area. FPGA-type strip structures, as also shown in conjunction with FIG. 3, in particular situated in the PAE, may permit implementation of pseudo-random noise generators in a particularly simple manner. In an example embodiment of the present invention, if individual output bits obtained stepwise always from a single FPGA cell are written back to the FPGA cell, a pseudo-random noise may also be generated creatively using a single cell (see FIG. 5).

In principle, the coupling advantages in the case of data block streams described above may be achievable via the cache. In one example embodiment of the present invention, the cache may be designed in slices and then multiple slices may be simultaneously accessible, in particular all slices being simultaneously accessible. This may be advantageous when a plurality of threads is to be processed on the data processing logic cell field (XPP) and/or the sequential CPU(s), as explained below, whether via hyperthreading, multitasking and/or multithreading. Cache memory arrangements having slice access and/or slice access enabling control arrangements may therefore be provided. For example, a separate slice may be assigned to each thread. This may make it possible later in processing the threads to ensure that the proper cache areas are accessed when the command group to be processed using the thread is resumed.

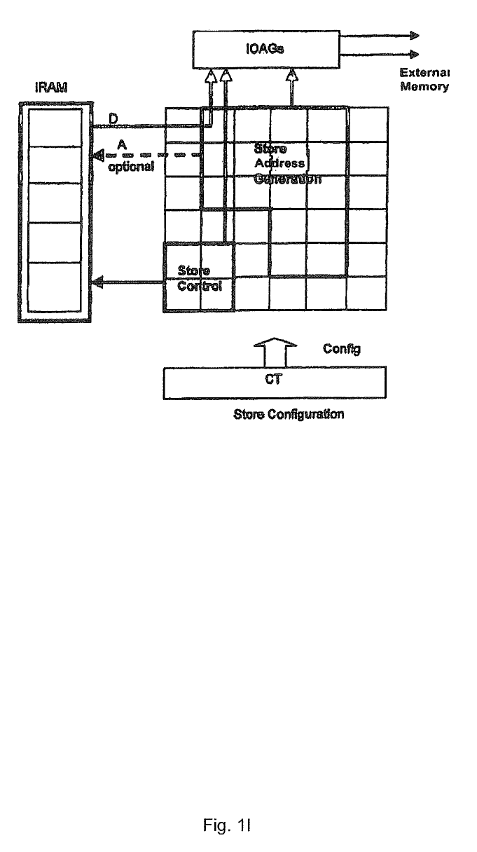

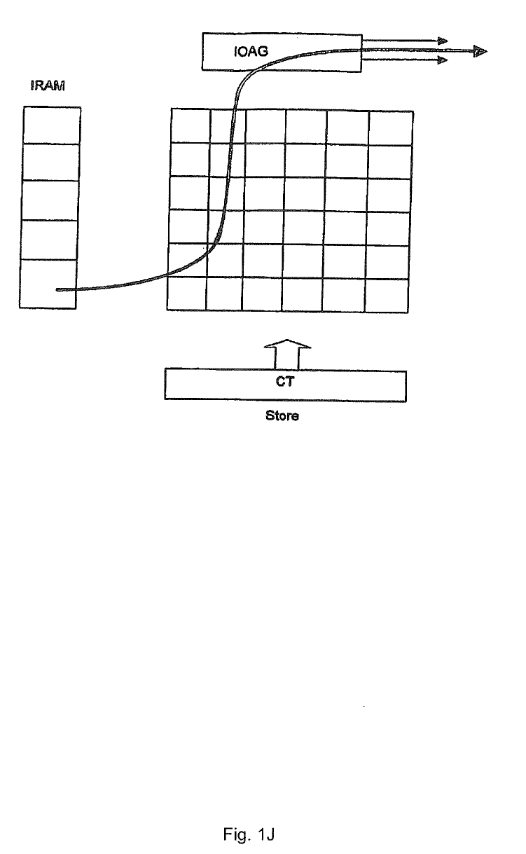

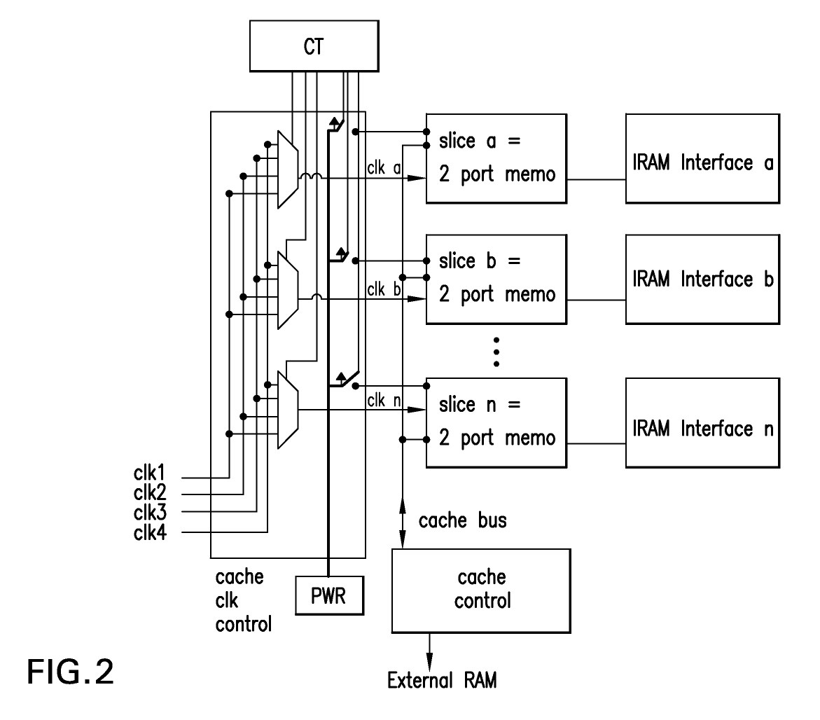

The cache need not necessarily be divided into slices, and if this is the case, a separate thread need not necessarily be assigned to each slice. Further, there may be cases in which not all cache areas are being used simultaneously or temporarily at a given point in time. Instead, it is to be expected that in typical data processing applications such as those occurring with handheld mobile telephone (cell phones), laptops, cameras and so forth, there are frequently times during which the entire cache is not needed. Therefore, in an example embodiment of the present invention, individual cache areas may be separable from the power supply so that their power consumption drops significantly, in particular to zero or almost zero. In a slice-wise cache design, this may occur by shutting down the cache in slices via suitable power disconnection arrangements (see FIG. 2, for example). The disconnection may be accomplished either by cycling down, clock disconnection, or power disconnection. In particular, access recognition may be assigned to an individual cache slice or the like, this access recognition being designed to recognize whether a particular cache area, i.e., a particular cache slice, has a thread, hyperthread, or task assigned to it at the moment, by which it is being used. If the access recognition then ascertains that this is not the case, typically disconnection from the clock and/or even from the power may then be possible. On reconnecting the power after a disconnection, immediate response of the cache area may be possible again, i.e., no significant delay need be expected due to turning the power supply on and off if implemented in hardware using conventional suitable semiconductor technologies. This is appropriate in many applications independently of the use with logic cell fields.

In an example embodiment of the present invention, although there may be a particularly efficient coupling with respect to the transfer of data and/or operands in blockwise form in particular, nevertheless no balancing is necessary in such a way that exactly the same processing time is necessary in a sequential CPU and XPP and/or data processing logic cell field. Instead, the processing may be performed in a manner which is practically often independent, in particular in such a way that the sequential CPU and the data processing logic cell field system may be considered as separate resources for a scheduler or the like. This may allow immediate implementation of known data processing program splitting technologies, such as multitasking, multithreading, and hyperthreading. A resulting advantage that path balancing is not necessary, i.e., balancing between sequential parts (e.g., on a RISC unit) and data flow parts (e.g., on an XPP), may result in any number of pipeline stages optionally being run through, e.g., within the sequential CPU (i.e., the RISC functional units), for example, cycling in a different way is possible and so forth. Further, according to embodiments of the present invention, by configuring a load configuration and/or a store configuration into the XPP or other data processing logic cell fields, the data may be loaded into the field or written out of it at a rate which is no longer determined by the clock speed of the CPU, the speed at which the opcode fetcher works or the like. In other words, the sequence control of the sequential CPU is no longer a bottleneck restriction for the data throughput through the data processing logic cell field without there being even a loose coupling.

According to an example embodiment of the present invention, it may be possible to use known CTs (or configuration managers (CMs) or configuration tables) for an XPP unit to use the configuration of one or more XPP fields also designed hierarchically with multiple CTs and at the same time one or more sequential CPUs more or less as multithreading scheduler and hardware management, which has the inherent advantage that known technologies (FILMO, etc.) may be used for the hardware-supported management in multithreading, but alternatively and/or additionally, in particular in a hierarchical arrangement, it is possible for a data processing logic cell field like an XPP to receive configurations from the opcode fetcher of a sequential CPU via the coprocessor interface. This may result in a call being instantiable by the sequential CPU and/or another XPP, resulting in data processing on the XPP. The XPP may then be kept in the data exchange, e.g., via the cache coupling described here and/or via LOAD and/or STORE configurations which provide address generators for loading and/or write-back of data in the XPP and/or data processing logic cell field. In other words, coupling of a data processing logic cell field in the manner of a coprocessor and/or thread resources is possible while at the same time data loading in the manner of data streaming is taking place through cache coupling and/or I/O port coupling.

The coprocessor coupling, i.e., the coupling of the data processing logic cell field, may typically result in scheduling for this logic cell field as well as also taking place on the sequential CPU or on a higher level scheduler unit and/or corresponding scheduler arrangements. In such a case, threading control and management may take place in practical terms on the scheduler and/or the sequential CPU. Although this is possible per se, this will not necessarily be the case at least in all embodiments of the present invention. Instead, the data processing logic cell field may be used by calling in the traditional way as is done with a standard coprocessor, e.g., in the case of 8086/8087 combinations.

In addition, in an example embodiment of the present invention, regardless of the type of configuration, whether via the coprocessor interface, the configuration manager of the XPP and/or of the data processing logic cell field or the like, where the CT also functions as a scheduler, or in some other way, it is possible, in and/or directly on the data processing logic cell field and/or under management of the data processing logic cell field, to address memories, in particular internal memories, in particular, in the case of the XPP architecture, such as that known from the various previous patent applications and publications by the present applicant, RAM PAEs or other similarly managed or internal memories, as a vector register, i.e., to store the data quantities loaded via the LOAD configuration like vectors as in vector registers in the internal memories and then, after reconfiguring the XPP and/or the data processing logic field, i.e., overwriting and/or reloading and/or activating a new configuration which performs the actual processing (in this context, for such a processing configuration, reference may also be made to a plurality of configurations which are to be processed in wave mode and/or sequentially), to access them as in the case of a vector register and then store the results thus obtained and/or intermediate results in turn in the internal memories or external memories managed via the XPP like internal memories to store these results there. The memory written in this way in the manner of a vector register with processing results using XPP access may then be written back in a suitable manner by loading the STORE configuration after reconfiguring the processing configuration. This, in turn, may take place in the manner of data streaming, whether via the I/O port directly into external memory areas and/or into cache memory areas which may then be accessed by the sequential CPU, other configurations on the XPP, which previously generated the data, and/or another corresponding data processing unit.

According to one example embodiment of the present invention, at least for certain data processing results and/or interim results, the memory and/or vector register arrangement in which the resulting data is to be stored are not internal memories into which data may be written via STORE configuration in the cache area or some other area which the sequential CPU or another data processing unit may access. Instead, the results may be written directly into corresponding cache areas, in particular, access-reserved cache areas, which may be organized like slices in particular. This may have the disadvantage of a greater latency, in particular when the paths between the XPP or data processing logic cell field unit and the cache are so long that the signal propagation times become significant, but it may result in no additional STORE configuration being needed. Such storage of data in cache areas may be possible, as described above, due to the fact that the memory to which the data is written is located in physical proximity to the cache controller and is designed as a cache. Alternatively and/or additionally there is also the possibility of placing part of an XPP memory area, XPP-internal memory or the like, in particular in the case of RAM via PAEs (see PACT31: DE 102 12 621.6, WO 03/036507), under the management of one or more sequential cache memory controllers. This may have advantages when minimizing the latency when storing the processing results, which are determined within the data processing logic cell field, whereas the latency in the case of access by other units to the memory area, which then functions only as a “quasi-cache,” may play little or no role.

According to another embodiment of the present invention, the cache controller of the traditional sequential CPU may address a memory area as a cache, this memory area being physically located on and/or at the data processing logic cell field without being used for the data exchange with it. This may have the advantage that, when applications having a low local memory demand are running on the data processing logic cell field, and/or when only a few additional configurations are needed, based on the available storage volume, this may be available as a cache to one or more sequential CPUs. The cache controller may be designed for management of a cache area having a dynamic extent, i.e., of varying size. Dynamic cache size management and/or cache size management arrangements for dynamic cache management may typically take into account the work load and/or the input/output load on the sequential CPU and/or the data processing logic cell field. In other words, it is possible to analyze, for example, how many NOP data accesses there are in a given unit of time to the sequential CPU and/or how many configurations in the XPP field should be stored in advance in memory areas provided for this purpose to be able to permit rapid reconfiguration, whether by way of wave reconfiguration or in some other way. The dynamic cache size described here may thus be a runtime dynamic, i.e., the cache controller may manage a prevailing cache size, which may change from one clock pulse to the other or from one clock pulse group to the other. Moreover, the access management of an XPP and/or data process logic cell field including access as an internal memory as is the case with a vector register and as a cache-type memory for external access, with regard to the memory accesses, has already been described in DE 196 54 595 and PCT/DE 97/03013 (PACT03). The publications cited are herewith incorporated fully by reference thereto for disclosure purposes.

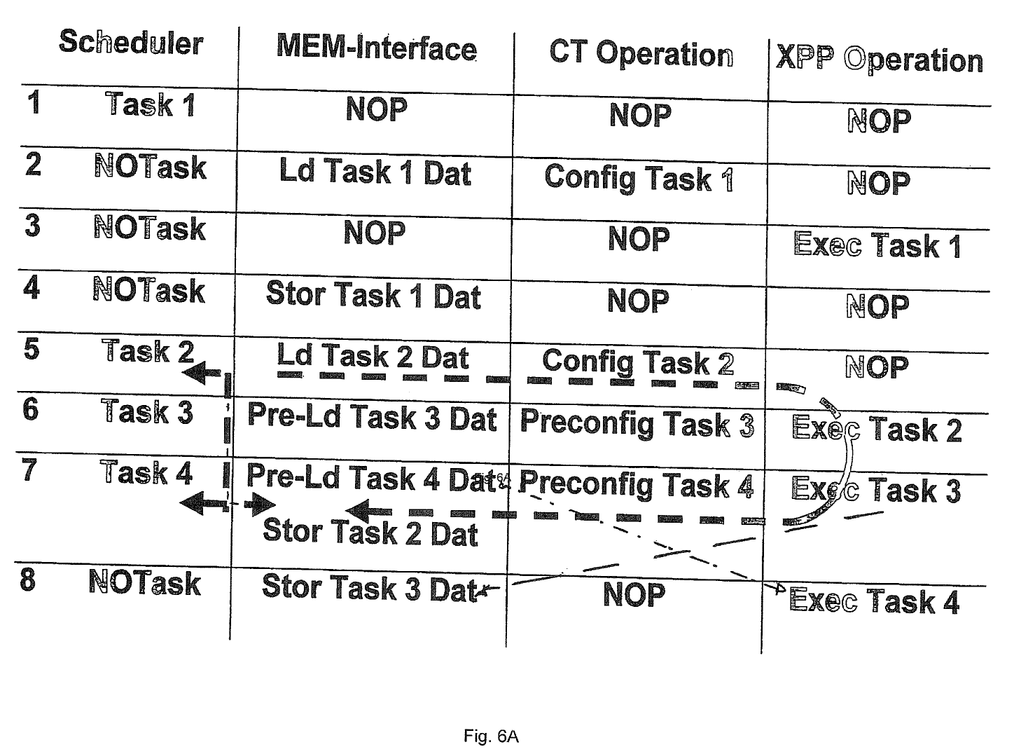

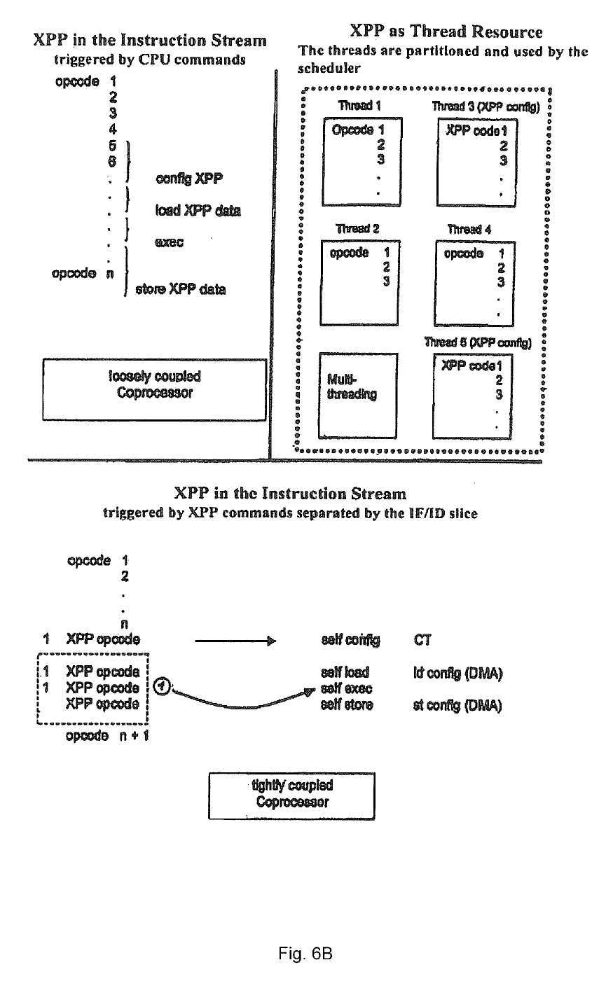

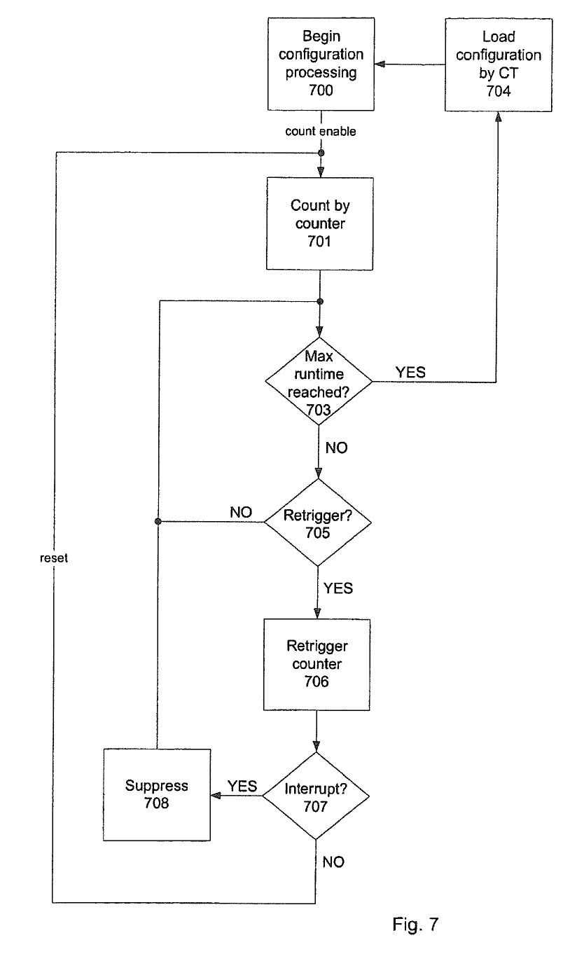

Reference was made above to data processing logic cell fields which are runtime reconfigurable in particular. The fact that a configuration management unit (CT and/or CM) may be provided for these systems was discussed. Management of configurations per se is known from the various patents and applications by the present applicant, to which reference has been made for disclosure purposes, as well as the applicant's other publications. Such units and their mechanism of operation via which configurations not yet currently needed are preloadable, in particular independently of connections to sequential CPUs, etc., may also be highly usable for inducing a task switch, a thread switch, and/or a hyperthread switch in multitasking operation, in hyperthreading, and/or in multithreading (see FIGS. 6a through 6c, for example). That, during the runtime of a thread or task, configurations for different tasks, i.e., threads and/or hyperthreads, may also be loaded into the configuration memory in the case of a single cell or a group of cells of the data processing logic cell field, i.e., a PAE of a PAE field (PA), for example, may be used to do so. That is, in the case of a blockade of a task or thread, e.g., when it is necessary to wait for data because the data is not yet available, whether because it has not yet been generated or received by another unit, e.g., because of latencies, or because a resource is currently still being blocked by another access, configurations for another task or thread may be preloadable and/or preloaded and it is possible to switch to them without the time overhead of having to wait for a configuration switch in the case of a shadow-loaded configuration in particular. In principle, it is possible to use this technique even when the most probable continuation is predicted within a task and a prediction is not correct (prediction miss), but this type of operation is preferred in prediction-free operation. In the case of use with a purely sequential CPU and/or multiple purely sequential CPUs, in particular exclusively with such CPUs, multithreading management hardware may thus be implemented by adding a configuration manager. Reference is made in this regard in particular to PACT10 (DE 198 07 872.2, WO 99/44147, WO 99/44120) and PACT17 (DE 100 28 397.7, WO 02/13000). It may be regarded as sufficient, in particular if hyperthreading management is desired for a CPU and/or a few sequential CPUs, to omit certain partial circuits like the FILMO as described in the patents and applications to which reference has been made specifically. In particular, this also describes the use of the configuration manager described there with and/or without FILMO for hyperthreading management for one or more purely sequentially operating CPUs with or without connection to an XPP or another data processing logic cell field. A plurality of CPUs may be implemented using the known techniques, as are known in particular from PACT31 (DE 102 12 621.6-53, PCT/EP 02/10572) and PACT34 (DE 102 41 812.8, PCT/EP 03/09957) in which one or more sequential CPUs are provided within an array, utilizing one or more memory areas in the data processing logic cell field in particular for construction of the sequential CPU, in particular as an instruction register and/or data register. It should also be pointed out here that previous patent applications such as PACT02 (DE 196 51 075.9-53, WO 98/26356), PACT04 (DE 196 54 846.2-53, WO 98/29952), and PACT08 (DE 197 04 728.9, WO 98/35299) have already disclosed how sequencers having ring and/or random access memories may be constructed.

A task switch and/or a thread switch and/or a hyperthread switch using the known CT technology—see PACT10 (DE 198 07 872.2, WO 99/44147, WO 99/44120) and PACT17 (DE 100 28 397.7, WO 02/13000) —may take place. Performance slices and/or time slices may be assigned by the CT to a software-implemented operating system scheduler or the like which is known per se, during which it may be determined which parts per se are to be processed subsequently by which tasks or threads, assuming that resources are free. An example may be given in this regard as follows. First, an address sequence may be generated for a first task. According to this, data may be loaded from a memory and/or cache memory to which a data processing logic cell field is connected in the manner described here, during the execution of a LOAD configuration. As soon as this data is available, processing of a second data processing configuration, i.e., the actual data processing configuration, may be initiated. This may also be preloaded because it is certain that this configuration is to be executed as long as no interrupts or the like require a complete task switch. In conventional processors, there is the problem known as cache miss, in which data is requested but is not available in the cache for load access. If such a case occurs in a coupling according to the present invention, it is possible to switch preferably to another thread, hyperthread and/or task which was intended for the next possible execution in particular by the operating system scheduler implemented through software in particular and/or another similarly acting unit, and therefore was loaded, e.g., in advance, into one of the available configuration memories of the data processing logic cell field, in particular in the background during the execution of another configuration, e.g., the LOAD configuration which has triggered the loading of the data for which the system is now waiting. Separate configuration lines may lead from the configuring unit to the particular cells directly and/or via suitable bus systems, such as those known in the related art per se, for advance configuration, undisturbed by the actual wiring of the data processing logic cells of the data processing logic cell field having a close granular design in particular. This design may permit undisturbed advance configuration without interfering with another configuration underway at that moment. Reference is made to PACT10 (DE 198 07 872.2, WO 99/44147, WO 99/44120), PACT17 (DE 100 28 397.7, WO 02/13000), PACT13 (DE 199 26 538.0, WO 00/77652), PACT02 (DE 196 51 075.9, WO 98/26356) and PACT08 (DE 197 04 728.9, WO 98/35299). If the configuration to which the system has switched during and/or because of the task thread switch and/or hyperthread switch has been processed and processing has been completed in the event of preferably indivisible, uninterruptible and thus quasi-atomic configurations—see PACT19 (DE 102 02 044.2, WO 2003/060747) and PACT11 (DE 101 39 170.6, WO 03/017095) —then in some cases another configuration may be processed as predetermined by the corresponding scheduler, in particular the scheduler close to the operating system and/or the configuration for which the particular LOAD configuration was executed previously. Before execution of a processing configuration for which a LOAD configuration has previously been executed, it is possible to test, e.g., by query of the status of the load configuration or the data loading DMA controller, to determine whether in the meantime the particular data has streamed into the array, i.e., whether the latency time has elapsed, as typically occurs, and whether the data is actually available.

In other words, if latency times occur, e.g., because configurations have not yet been configured into the system, data has not yet been loaded, and/or data has not yet been written back, they will be bridged and/or masked by the execution of threads, hyperthreads, and/or tasks which have already been preconfigured and are operating using data which is already available and/or which may be written back to resources which are already available for write-back. Latency times may be largely covered in this way and virtually 100% utilization of the data processing logic cell field may be achieved, assuming an adequate number of threads, hyperthreads, and/or tasks to be executed per se.

By providing an adequate number of XPP-internal memory resources which are freely assigned to threads, e.g., by the scheduler or the CT, the cache and/or write operations of several simultaneous and/or superimposed threads may be executed, which may have a particularly positive effect on bridging any latencies.

Using the system described here with regard to data stream capability in the case of simultaneous coupling to a sequential CPU and/or with regard to coupling an XPP array and/or data processing logic cell field and simultaneously a sequential CPU to a suitable scheduler unit such as a configuration manager or the like, real time-capable systems may be readily implementable. For real time capability, it may be necessary to ensure a response to incoming data and/or interrupts signaling the arrival of data in particular within a maximum period of time, which is not to be exceeded in any case. This may be accomplished, for example, by a task switch to an interrupt and/or, e.g., in the case of prioritized interrupts, by ascertaining that a given interrupt is to be ignored at the moment, in which case it might be required for this to be defined within a certain period of time. A task switch in such real time-capable systems may be achievable in three ways, namely when a task has been running for a certain period of time (timer principle), when a resource is not available, whether due to being blocked by some other access or due to latencies in access thereto, e.g., reading and/or writing access, i.e., in the case of latencies in data access, and/or in the event of occurrence of interrupts.

A runtime-limited configuration in particular may also trigger a watchdog and/or parallel counter on a resource which is to be enabled and/or switched for processing the interrupt. Although it has otherwise been stated explicitly—see also PACT29 (DE 102 12 622.4, WO 03/081454) —that new triggering of the parallel counter and/or watchdog to increase runtime is suppressible by a task switch, according to the present invention, an interrupt may also have a blocking effect, i.e., according to a task switch, parallel counter—and/or watchdog—and new trigger, i.e., in such a case it is possible to prevent the configuration itself from increasing its maximum possible runtime by new triggering.

The real time capability of a data processing logic cell field may now be achieved, e.g., by implementing one or more of three exemplary embodiments.

According to a first embodiment, within a resource addressable by the scheduler and/or the CT, there may be a switch to processing an interrupt, for example. If the response times to interrupts or other requests are so long that a configuration may still be processed without interruption during this period of time, then this is noncritical in particular, since a configuration for interrupt processing may be preloaded onto the resource which is to be switched to processing the interrupt, and this may be done during processing of the currently running configuration. The choice of the interrupt processing configuration to be preloaded is to be made by the CT, for example. It is possible to limit the runtime of the configuration on the resource which is to be enabled and/or switched for the interrupt processing. Reference is made in this regard to PACT29/PCT (PCT/DE03/000942).

In systems which must respond to interrupts more quickly, in one embodiment of the present invention, a single resource, i.e., for example, a separate XPP unit and/or parts of an XPP field, may be reserved for such processing. If an interrupt which must be processed quickly then occurs, it is possible to either process a configuration preloaded for particularly critical interrupts in advance or to begin immediately loading an interrupt processing configuration into the reserved resource. A choice of the particular configuration required for the corresponding interrupt is possible through appropriate triggering, wave processing, etc.

Using the methods already described, it may be possible to obtain an instant response to an interrupt by achieving code re-entrance by using LOAD/STORE configurations. After each data processing configuration or at given points in time, e.g., every five or ten configurations, a STORE configuration may be executed and then a LOAD configuration may be executed while accessing the memory areas to which data was previously written. When it is certain that the memory areas used by the STORE configuration will remain unaffected until another configuration has stored all relevant information (states, data) by progressing in the task, it may then be certain that the same conditions will be obtained again on reloading, i.e., on re-entrance into a configuration previously initiated but not completed. Such an insertion of LOAD/STORE configurations with simultaneous protection of STORE memory areas which are not yet outdated may be very easily generated automatically without additional programming complexity, e.g., by a compiler. Resource reservation may be advantageous there. It should also be pointed out that in resource reservation and/or in other cases, it is possible to respond to at least a quantity of highly prioritized interrupts by preloading certain configurations.

According to another embodiment of the response to interrupts, when at least one of the addressable resources is a sequential CPU, an interrupt routine in which a code for the data processing logic cell field is prohibited may be processed on it. In other words, a time-critical interrupt routine may be processed exclusively on a sequential CPU without calling XPP data processing steps. This may ensure that the processing operation on the data processing logic cell field is not to be interrupted and then further processing may take place on this data processing logic cell field after a task switch. Although the actual interrupt routine might not have an XPP code, it is nevertheless possible to ensure that at a later point in time, which is no longer relevant to real time, following an interrupt it is possible to respond with the XPP to a state and/or data detected by an interrupt and/or a real time request using the data processing logic cell field.

What is claimed is:

1. A processor comprising:
a plurality of processor cores, including at least one sequential processor core; and
a first level cache memory;
wherein the first level cache memory is connected to and shared by the processor cores.

2. The processor of claim 1, wherein at least one of the a plurality of processor cores has multi-thread capabilities.

3. The processor of any one of claims 1 and 2, wherein the first level cache is an at least two-port cache.

4. The processor of any one of claims 1 and 2, wherein each processor core is capable of transmitting data to another processor core via the shared first level cache.

5. The processor of claim 4, wherein transmitting of data includes transmitting data blocks.

6. The processor of any one of claims 1 and 2, wherein at least one of the plurality of processor cores is a coprocessor.

7. The processor of claim 6, wherein the coprocessor core comprises a plurality of Arithmetic Logic Units.

8. The processor of claim 7, wherein the coprocessor core is runtime configurable.

9. The processor of claim 8, wherein the coprocessor core is a FPGA.

10. The processor of claim 8, wherein the coprocessor core comprises FPGA elements.

11. The processor of claim 6, wherein the coprocessor core is configurable.

12. The processor of claim 1, further comprising an arrangement for moving data to or from the first level cache from or to a higher level memory.

13. The processor of claim 12, wherein the arrangement for moving is controlled by at least one prefetch instruction.

14. The processor of claim 12, wherein the arrangement for moving is controlled by at least one flush instruction.

15. The processor of any one of claims 13 and 14, wherein a block of data is moved in accordance with the instruction.

16. The processor of claim 15, wherein the instruction at least defines a size of the data block to be moved.

17. The processor of claim 15, wherein the instruction defines a multi-dimensional block of data to be moved.

18. The processor of any one of claims 13 and 14, wherein the instruction is generated by a compiler.

19. The processor of any one of claims 13 and 14, further comprising an arrangement for activating data processing of at least one of the processor cores after completion of a move of a block of data in accordance with the instruction.

20. A system comprising:
a plurality of processor cores, including at least one sequential processor core; and
a first level cache memory;
wherein the first level cache memory is connected to and shared by the processor cores.

21. The system of claim 20, wherein at least one of the plurality of processor cores has multi-thread capabilities.

22. The system of any one of claims 20 and 21, wherein the first level cache is an at least two-port cache.

23. The system of any one of claims 20 and 21, wherein each processor core is capable of transmitting data to another processor core via the shared first level cache.

24. The system of claim 23, wherein transmitting of data includes transmitting data blocks.

25. The system of any one of claims 20 and 21, wherein at least one of the plurality of processor cores is a coprocessor.

26. The system of claim 25, wherein the coprocessor core comprises a plurality of Arithmetic Logic Units.

27. The system of claim 26, wherein the coprocessor core is runtime configurable.

28. The system of claim 27, wherein the coprocessor core is a FPGA.

29. The system of claim 27, wherein the coprocessor core comprises FPGA elements.

30. The system of claim 25, wherein the coprocessor core is configurable.

31. The system of claim 20, further comprising an arrangement for moving data to or from the first level cache from or to a higher level memory.

32. The system of claim 31, wherein the arrangement for moving is controlled by at least one prefetch instruction.

33. The system of claim 31, wherein the arrangement for moving is controlled by at least one flush instruction.

34. The system of any one of claims 32 and 33, wherein a block of data is moved in accordance with the instruction.

35. The system of claim 34, wherein the instruction at least defines a size of the data block to be moved.

36. The system of claim 34, wherein the instruction defines a multi-dimensional block of data to be moved.

37. The system of any one of claims 32 and 33, wherein the instruction is generated by a compiler.

38. The system of any one of claims 32 and 33, further comprising an arrangement for activating data processing of at least one of the processor cores after completion of a move of a block of data in accordance with the instruction.

39. A system comprising:
a plurality of processor cores, including at least one sequential processor core, and
at least one coprocessor core;
wherein:
the at least one sequential processor core has multi-thread capabilities; and
the at least one coprocessor core is integrated into the at least one sequential processor core as a thread resource.

40. The system of claim 39, wherein the coprocessor core comprises a plurality of Arithmetic Logic Units.

41. The system of claim 40, wherein the coprocessor core is configurable.

42. The system of claim 40, wherein the coprocessor core is runtime configurable.

43. The system of claim 42, wherein the coprocessor core is a FPGA.

44. The system of claim 42, wherein the coprocessor core comprises FPGA elements.

45. The system of claim 40, wherein the coprocessor core operates as a vector processing unit.

46. The system of claim 39, further comprising a first level cache memory, wherein the first level cache memory is connected to and shared by the processor cores.

47. The system of claim 46, wherein the first level cache memory is an at least two-port cache.

48. The system of claim 47, wherein each processor core is capable of transmitting data to another processor core via the shared first level cache memory.

49. The system of claim 47, wherein the transmitting of data includes transmitting data blocks.

50. A method comprising:
a first and a second processor core transmitting data between the first and second processor cores using a first level cache.

51. The method of claim 50, wherein at least one of the processor cores has multi-thread capabilities.

52. The method of claim 50, wherein at least one of the processor cores comprises a matrix of Arithmetic Logic Units operating as a vector processing unit.

53. The method of claim 50, wherein the data is transmitted in blocks.

54. The method of claim 50, wherein a data transfer between the first level cache and a higher level memory is explicitly controlled by instructions.

55. The method of claim 54, wherein the instructions include at least one prefetch instruction.

56. The method of claim 54, wherein the instructions include at least one flush instruction.

57. The method of any one of claims 55 and 56, wherein the instruction at least defines a size of a data block to be moved.

58. The method of any one of claims 55 and 56, wherein the instruction defines a multi-dimensional block of data to be moved.

59. The method of any one of claims 55 and 56, wherein the instruction is generated by a compiler.

60. The method of any one of claims 55 and 56, wherein data processing of at least one of the processor cores is activated after completion of the move of a block of data.

61. The method of any one of claims 55 and 56, wherein the data blocks are moved in the background during processing of data by at least one of the processor cores.

62. A system comprising:
a plurality of processor cores, including at least one sequential processor core and at least one configurable coprocessor core;
at least one first level cache connected to the sequential processor; and
at least one memory;
wherein:
the at least one sequential processor core has multi-thread capabilities; and
the at least one first level cache is connected to and shared by the plurality of processor cores.

63. The system of claim 62, wherein the at least one sequential processor core is capable of transmitting data to the at least one configurable coprocessor core via the shared at least one first level cache.

64. The system of claim 63, wherein the coprocessor core is connected to the sequential processor core as a thread resource.

65. The system of claim 63, wherein the sequential processor core is capable of moving threads to the coprocessor core.

66. The system of claim 63, wherein the coprocessor core executes threads.

67. The system of claim 63, wherein the coprocessor core executes tasks.

68. The system of claim 63, wherein the coprocessor core comprises a plurality of Arithmetic Logic Units.

69. The system of claim 68, wherein the coprocessor core is configurable.

70. The system of claim 68, wherein the coprocessor core is runtime configurable.

71. The system of claim 70, wherein the coprocessor core is a FPGA.

72. The system of claim 70, wherein the coprocessor core comprises FPGA elements.

73. The system of claim 68, wherein the coprocessor core operates as a vector processor.

74. The system of claim 62, further comprising an arrangement for moving data to or from the at least one first level cache from or to a higher level memory.

75. The system of claim 74, wherein the arrangement for moving is controlled by at least one prefetch instruction.

76. The system of claim 74, wherein the arrangement for moving is controlled by at least one flush instruction.

77. The system of any one of claims 75 and 76, wherein a block of data is moved in accordance with the instruction.

78. The system of claim 77, wherein the instruction at least defines a size of the data block to be moved.

79. The system of claim 77, wherein the instruction defines a multi-dimensional block of data to be moved.

80. The system of claim 77, wherein the data block is moved in the background during processing of data by at least one of the processor cores.

81. The system of any one of claims 75 and 76, wherein the instruction is generated by a compiler.

82. The system of any one of claims 75 and 76, further comprising an arrangement for activating data processing of at least one of the processor cores after completion of a move of a block of data.

83. A method comprising:
using a shared memory, connected via a cache to at least one sequential processor core having multi-thread capabilities and connected to a FPGA core, for transmitting data between the cores.

84. The method of claim 83, wherein the FPGA core is connected to the sequential processor core as a thread resource.

85. The system of claim 83, wherein the sequential processor core is capable of moving threads to the FPGA core.

86. The method of claim 83, wherein the FPGA core executes threads.

87. The method of claim 83, wherein the FPGA core executes tasks.

88. The method of claim 83, wherein the FPGA core comprises a plurality of Arithmetic Logic Units.

89. The method of claim 88, wherein the FPGA core is configurable.

90. The method of claim 88, wherein the FPGA core is runtime configurable.

91. The method of claim 88, wherein the FPGA core operates as a vector processor.

92. The method of claim 83, further comprising moving data, by a moving arrangement, to or from the shared memory from or to a higher level memory.

93. The method of claim 92, wherein the moving arrangement is controlled by at least one prefetch instruction.

94. The method of claim 92, wherein the moving arrangement is controlled by at least one flush instruction.

95. The method of any one of claims 93 and 94, wherein a block of data is moved in accordance with the instruction.

96. The method of claim 95, wherein the instruction at least defines a size of the data block to be moved.

97. The method of claim 95, wherein the instruction defines a multi-dimensional block of data to be moved.

98. The method of claim 95, further comprising activating data processing of at least one of the cores after completion of the move of the block of data.

99. The method of claim 95, wherein the data block is moved in the background during processing of data by at least one of the cores.

100. The method of any one of claims 93 and 94, wherein the instruction is generated by a compiler.

101. A method for operating a processor having multi-thread capabilities comprising:
checking a readiness of a data transfer by a first thread; and
switching to at least one second thread if the readiness is not determined in the checking step.

102. The method of claim 101, further comprising performing the data transfer in the background during execution of the at least one second thread.

103. The method of any one of claims 101 and 102, wherein the readiness is not given in case of a cache miss.

104. The method of any one of claims 101 and 102, wherein readiness is not given if read data is not available.

105. The method of any one of claims 101 and 102, wherein readiness is not given if write data cannot be written back.

106. The method of any one of claims 101 and 102, further comprising selecting as the at least one second thread, a thread that is ready for execution.

107. A method for operating a processor having multi-thread capabilities comprising
checking, by a first thread, if a data resource is ready for at least one of reading and writing of data, the data resource being one of a data receiver and a data sender; and
switching to at least one second thread if the data resource is not determined, in the checking step, to be ready.

108. The method of claim 107, wherein the data resource gets ready in the background during execution of the at least one second thread.

109. The method of any one of claims 107 and 108, further comprising selecting as the at least one second thread, a thread that is ready for execution.

110. A system comprising:
a plurality of processor cores;
a plurality of memory cores, the plurality of memory cores forming a first level cache that is (a) connected to and shared by the processor cores, and (b) partitioned into a plurality of slices, at least some of the plurality slices being simultaneously accessible in parallel by at least some of the plurality of processor cores.

111. The system of claim 110, wherein at least some of the processor cores have multi-thread capabilities.

112. The system of any one of claims 110 and 111, further comprising a power saving arrangement for reducing energy consumption of temporarily unused ones of the slices.

113. The system of claim 112, wherein the power saving arrangement reduces a clock frequency.

114. The system of claim 112, wherein the power saving arrangement switches off a clock.

115. The system of claim 112, wherein the power saving arrangement switches off a power supply.

116. A processor comprising:
a plurality of processor cores;
a plurality of memory cores, the plurality of memory cores forming a first level cache that is (a) connected to and shared by the processor cores, and (b) partitioned into a plurality of slices, at least some of the plurality slices being simultaneously accessible in parallel by at least some of the plurality of processor cores.

117. The processor of claim 116, wherein at least some of the processor cores have multi-thread capabilities.

118. The processor of any one of claims 116 and 117, further comprising a power saving arrangement for reducing energy consumption of temporarily unused ones of the slices.

119. The processor of claim 117, wherein the power saving arrangement reduces a clock frequency.

120. The processor of claim 117, wherein the power saving arrangement switches off a clock.

121. The processor of claim 117, wherein the power saving arrangement switches off a power supply.
